(19) United States
(12) Patent Application Publication
(10) Pub. No.: US 2022/0413882 A1
(43) Pub. Date: Dec. 29, 2022

(54) OPERATING ENVIRONMENT PERSONALIZATIONS

(71) Applicant: Hewlett-Packard Development Company, L.P., Spring, TX (US)

(72) Inventors: Christoph Graham, Spring, TX (US); Irwan Halim, Spring, TX (US)

(21) Appl. No.: 17/362,627

(22) Filed: Jun. 29, 2021

(51) Int. Cl. G06F 9/455; H04L 29/08

(52) U.S. Cl. CPC G06F 9/45533; H04L 67/306; H04L 67/025

(57) ABSTRACT

In some examples, a method includes receiving a personalization setting from a first agent on a first device. In some examples, the first device provides a local operating environment. In some examples, the method includes sending the personalization setting to a second agent on a second device that provides a virtualized operating environment, to coordinate a behavior or appearance of the virtualized operating environment with a personalized behavior or appearance of the local operating environment.

### BACKGROUND

The use of electronic devices has expanded. Computing devices are a kind of electronic device that include electronic circuitry for performing processing. As processing capabilities have expanded, computing devices have been utilized to perform more functions. For example, a variety of computing devices are used for work, communication, and entertainment. Computing devices may be linked to a network to facilitate communication between computing devices.

### BRIEF DESCRIPTION OF THE DRAWINGS

FIG. 1 is a flow diagram illustrating an example of a method for operating environment personalization;

FIG. 2 is a thread diagram illustrating an example of operating environment personalization;

FIG. 3 is a block diagram of an example of an apparatus that may be used for operating environment personalization; and

FIG. 4 is a block diagram illustrating an example of a computer-readable medium for operating device personalization.

### DETAILED DESCRIPTION

An operating environment may include an interactive interface (e.g., user interface (UI)) produced by a computing device. For instance, an operating environment may include resources (e.g., allocated memory resources, processor resources, and/or network resources, etc.) to provide computation and/or interface elements for interaction with a computing device. Examples of operating environments include a desktop, application UI, window, etc. A local operating environment is an operating environment that is provided by a local computing device (e.g., without transmitting an interactive interface to a remote device, not provided by a device that is remote to the end user, etc.). Examples of a local operating environment include a local desktop, an application provided by a local computing device, etc. A local computing device is a computing device that is local to an end user (e.g., located in a building with the end user and/or produced by a computing device interfacing directly with an end user). A virtualized operating environment is an operating environment that is provided from a remote computing device. For example, a virtualized operating environment may be hosted by a remote computing device and/or an interactive interface of a virtualized operating environment may be transmitted to a local computing device from a remote device via a network. For instance, a virtualized operating environment may be transmitted to a local device by providing an interactive interface of the virtualized operating environment over a network. In some examples, the term “remote” may denote that an item is separate from another item, is connected to another item across a network or networks, is in a different area (e.g., room, building, etc.) than another item, and/or is located beyond a distance (e.g., one inch, one foot, one meter, one mile, etc.) from another item.

A hybrid operating environment is a combination of a local operating environment and a virtualized operating environment. In hybrid operating environments, end users may access a local operating environment and a virtualized operating environment(s) concurrently: the local operating environment that represents a local computing device, and a virtualized operating environment (e.g., potentially many virtualized operating environments) representing a remote application or applications. For instance, an end user may access applications in a virtualized Windows® (e.g., remote desktop) context.

A disparity may exist between a personalization setting in the local operating environment and the virtualized operating environment. A setting is an operation parameter (e.g., changeable operation parameter) of an operating environment. A personalization setting is a setting (e.g., appearance setting, behavior setting, etc.) that is customized to an end user. Examples of personalization settings include a resolution setting, font size, icon size, cursor sensitivity, macro, application template, audio setting, viewing mode such as light or dark mode, icon sorting, UI design (e.g., color, border style, etc.), window location, monitor mapping, operating system (OS) setting, taskbar location, etc. For instance, similar or corresponding personalization settings may be different between the local operating environment and the virtualized operating environment and/or between virtualized operating environments. In some examples, some personalization settings may not be customized to an end user. In some examples, a personalization setting or settings may be set by an administrator. In some examples, an administrator may delegate permissions (to an end user profile, for instance) for a subset of personalization settings that are allowed to be changed. In some examples, some personalization settings may be locked (e.g., non-modifiable by an end user).

For example, in virtualized operating environments, some settings may not be available to the end user. The end user may or may not have access rights to modify personalization settings in an operating environment or environments. In some cases, a local operating environment and a virtualized operating environment may be provided by different operating systems (OSes) and/or OS versions that provide different options to control personalization settings. This may lead to difficulty or incompatibility in synchronizing personalization settings between operating environments.

Some of the techniques described herein may provide personalization setting coordination between operating environments. For example, some of the techniques may increase personalization similarity or matching between a local operating environment and a virtualized operating environment and/or between virtualized operating environments. For instance, some examples of the techniques described herein may enable automatic personalization setting application and/or propagation across operating environments (without manual intervention in some examples).

An electronic device is a device that includes electronic circuitry (e.g., integrated circuitry, etc.). A computing device is an electronic device that includes a processor and/or logic circuitry. Examples of computing devices may include desktop computers, laptop computers, servers, tablet devices, smartphones, tablet device, televisions, game consoles, smart speakers, voice assistants, etc. A computing device may utilize processor(s) and/or logic circuitry to perform an operation or operations. In some examples, computing devices may execute instructions stored in memory to perform the operation(s). Instructions may be code and/or programming that specifies functionality or operation of the circuitry. In some examples, instructions may be stored in non-volatile memory (e.g., Read-Only Memory (ROM), Erasable Programmable Read-Only Memory (EPROM), Electrically Erasable Programmable Read-Only Memory (EEPROM), flash memory, etc.).

In some examples, a computing device may be linked to another electronic device or devices using a wired and/or wireless link. For example, a computing device may include a communication interface for linking to an electronic device (e.g., switch, router, server, and/or computer, etc.). Examples of wired communication interfaces may include an Ethernet interface, Universal Serial Bus (USB) interface, fiber interface, Lightning® interface, etc. In some examples, a computing device may include a wireless communication interface to send and/or receive wireless (e.g., radio frequency (RF)) signals. Examples of wireless communication interfaces may include an Institute of Electrical and Electronics Engineers (IEEE®) 802.11 (WI-FI®) interface, Bluetooth® interface, cellular (e.g., 3G, Long-Term Evolution (LTE®), 4G, 5G, etc.) interface, etc.

A link between electronic devices may be a direct link (e.g., without an intervening device) or an indirect link (e.g., with an intervening device or devices). For instance, a link may be established between electronic devices over a network using a modem(s), router(s), switch(es), hub(s), and/or repeater(s), etc.

Throughout the drawings, similar reference numbers may designate similar or identical elements. When an element is referred to without a reference number, this may refer to the element generally, with and/or without limitation to any particular drawing or figure. In some examples, the drawings are not to scale and/or the size of some parts may be exaggerated to more clearly illustrate the example shown. Moreover, the drawings provide examples in accordance with the description. However, the description is not limited to the examples provided in the drawings.

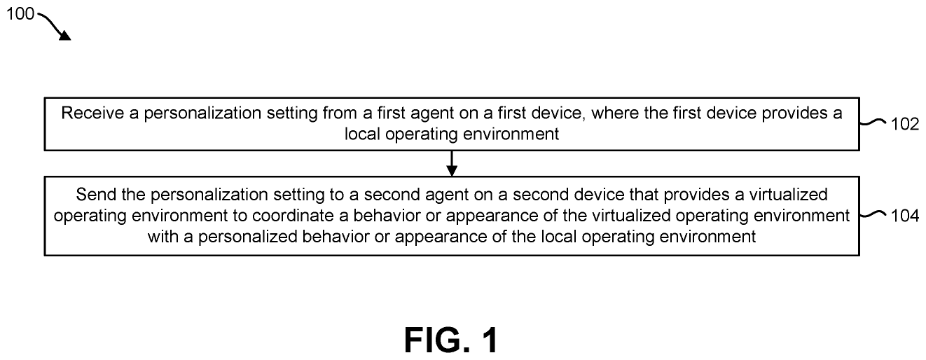

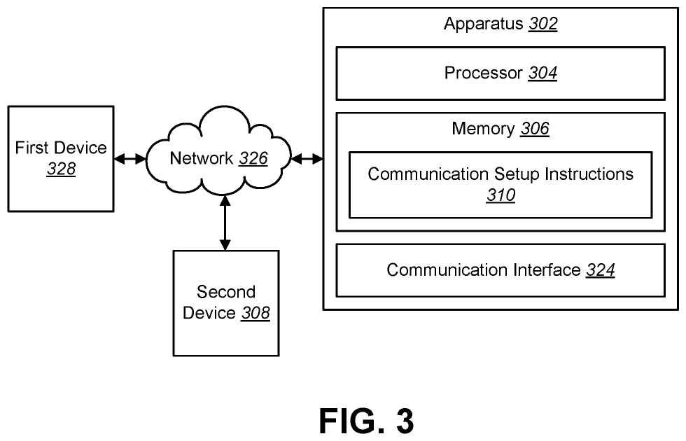

FIG. 1 is a flow diagram illustrating an example of a method 100 for operating environment personalization. The method 100 and/or a method 100 element or elements may be performed by an apparatus (e.g., computing device, server, etc.). For example, the method 100 may be performed by the apparatus 302 described in relation to FIG. 3.

The apparatus may receive 102 a personalization setting from a first agent on a first device. The first device may provide a local operating environment. For instance, the first device may provide a local operating environment for a local user. The first device may be a remote device. A remote device is a device that is separate from the apparatus. In some examples, a remote device may be linked to the apparatus via a communication network or networks. Examples of a remote device may include a computing device.

An agent is an application or program that performs an operation on a device for another device or program. For instance, the first device (e.g., a computing device) may have a first agent installed. The first agent may perform an operation on the first device for the apparatus. For instance, the first agent may detect a personalization setting change on the first device and may send the changed personalization setting to the apparatus. For example, the apparatus may receive 102 information representing a setting that customizes an appearance setting, a behavior setting, and/or another setting in the local operating environment.

In some examples, the personalization setting is an application layer setting. An application layer setting is a setting that personalizes an appearance and/or behavior of an application. Examples of application layer settings may include proofing settings, saving settings, display settings, toolbar settings, general settings, language settings, advanced settings, zoom settings, template settings, application macros, application shortcut settings, application window size, application window placement, application security settings, default playback settings, and/or other settings, etc.

In some examples, the personalization setting is a hardware device setting. A hardware device setting is a setting that personalizes a behavior of a hardware device. Examples of a hardware device may include a basic input/output system (BIOS), graphics processing unit (GPU), keyboard, mouse, monitor, processor, etc. Examples of hardware device settings may include resolution, monitor brightness, programmable button function, lighting (e.g., mouse, keyboard, chassis lighting, etc.), and/or other settings, etc.

In some examples, the personalization setting is translated from a local personalization setting that is specific to the local operating environment. For instance, the personalization setting may be translated from a local personalization setting that is specific to the local operating environment to a second personalization setting that is compatible with the virtualized operating environment. A local personalization setting may be expressed as data specific to the local operating environment. For instance, a local operating environment may specify a local personalization setting as “light mode” or “dark mode.” Another operating environment (e.g., a virtualized operating environment) may express a similar personalization setting as “white background, black text” or “black background, white text.” The first agent may translate the local personalization setting into a personalization setting that may be utilized by the apparatus and/or another agent (e.g., second agent) to function with another operating environment (e.g., operating system, application, etc.). For instance, the first agent may translate (e.g., reformat, genericize, encode, etc.) a local personalization setting to produce the personalization setting that is sent to the apparatus. In some examples, a personalization setting that exists in the local operation environment may not exist in the virtualized operating environment or vice versa. In some approaches, the apparatus and/or agent(s) may leave the personalization setting unaddressed in the operating environment that does not include a corresponding personalization setting. In some approaches, the apparatus and/or agent(s) may utilize other settings to achieve a similar effect (e.g., change a style sheet for an application in the virtualized operating environment to achieve a similar effect to a window appearance in a local operating environment, etc.).

In some examples, the method 100 may include storing the personalization setting in association with a user profile. For example, the apparatus may store the personalization setting received from the first agent. In some examples, the personalization setting may be stored in association with a user profile (e.g., name, identifier, employee number, data designating a user, etc.). For instance, the personalization setting may be stored in a data structure (e.g., object, table, tree, list, etc.) corresponding to the user profile. For instance, the data structure may include the user profile and/or may be associated with the user profile (e.g., may point to the user profile, may be linked to a table including the user profile, etc.). In some examples, the user profile may be stored on the apparatus and/or may be provided by the first agent.

In some examples, the personalization setting may be stored in association with a device identity (e.g., name, identifier, serial number, media access control (MAC) address, etc.). A device identity may identify a computing device (e.g., computing device that provides the local operating environment, workstation, etc.). For instance, the personalization setting may be stored in a data structure (e.g., object, table, tree, list, etc.) corresponding to the device identity. For instance, the data structure may include the device identity and/or may be associated with the device identity (e.g., may point to the device identity, may be linked to a table including the device identity, etc.). In some examples, the device identity may be stored on the apparatus and/or may be provided by the first agent.

The apparatus may send 104 the personalization setting to a second agent on a second device that provides a virtualized operating environment. For instance, the virtualized operating environment may be provided for a user profile and/or user. The second device may be a remote device. For example, the second device may be a computing device, server (e.g., virtual application server), etc., that is located remotely from the user. The virtualized operating environment may be hosted by the second device and/or may be sent to the first device over a network. The virtualized operating environment may provide a virtual application, virtual operating system, etc. Examples of the virtualized operating environment may include remote desktop, remote device screen streaming, a virtual application (e.g., virtual word processing, virtual spreadsheet, remote-hosted email, video streaming application, game streaming application, etc.), etc.

The apparatus may send 104 the personalization setting to coordinate a behavior or appearance of the virtualized operating environment with a personalized behavior or appearance of the local operating environment. For example, the second agent on the second device may receive the personalization setting. The second agent may utilize the personalization setting to adjust a corresponding setting or settings in the virtualized operating environment. For instance, if the personalization setting indicates a 2560×1440 resolution, the second agent may change a setting of the virtualized operating environment to provide a 2560×1440 resolution. In some examples, if the personalization setting indicates a default font size of 140%, the second agent may change a setting of the virtualized operating environment to depict a font size of 140%. In some examples, if the personalization setting indicates a macro associated with a keyboard shortcut in a word processing application, the second agent may change a setting of a virtualized word processing application to include the macro with a keyboard shortcut. In some examples, the second agent may change other settings to provide similar or matching personalization behaviors between the local operating environment and the virtual operating environment.

In some examples, the local operating environment may be produced with a first OS and the virtualized operating environment may be produced by a different second OS. For instance, the first OS and the second OS may differ in terms of platform and/or version. Examples of OSes that may be utilized to produce a local operating environment or a virtualized operating environment may include Windows 10, Windows 7, Windows Server® 2019, Unix®, Linux®, NetWare, macOS®, iOS®, Android™, etc. For example, the local operating environment may be produced with Microsoft Windows and the virtualized operating environment may be produced with Linux. The personalization setting translation described herein may be utilized to enable providing similar or matching personalization behaviors between operating environments provided by different OSes.

In some examples, the apparatus may receive a personalization setting request from the second agent, where the personalization setting request is triggered based on a request for the virtualized operating environment from the first device. For instance, the first device may send a request for the virtualized operating environment (e.g., remote desktop, virtual application, etc.) to the second device through the apparatus or independent of the apparatus. In response to receiving the request for the virtualized operating environment from the first device, the second agent may send the personalization setting request to the apparatus. A personalization setting request is information indicating a request for a personalization setting (e.g., any personalization setting(s)) pertaining to the virtualized operating environment. In some examples, the apparatus may determine that the personalization setting is stored. For instance, the apparatus may look up a personalization setting or settings stored on the apparatus for the virtualized operating environment. In some examples, personalization settings may be stored in accordance with the structure illustrated in Listing (1).

Listing (1)

| { | |
|---|---|
| Property1=Value1 | |
| Property2=Value2 | |
| Property3= | { |
| | Property4=Value4 |
| | Property5=Value5 |
| | } |

}

In Listing (1), “Property1,” “Property2,” “Property3,” “Property4,” and “Property5” examples of types of personalization settings, and “Value1,” “Value2,” “Value4,” and “Value5” denote values indicating personalization settings. As illustrated in Listing (1), properties may be nested in some examples. In some examples, a data structure to store the personalization settings may be transferred across services. In some examples, personalization settings data may be stored in multiple locations and/or formats (e.g., relational databases, key-value stores, document-based databases, etc.).

In some examples, sending 104 the personalization setting to the second agent may be performed in response to determining that the personalization setting is stored. For instance, the apparatus may send the personalization setting if the apparatus has a stored personalization setting relevant to the personalization setting request. Otherwise, the apparatus may not respond or may send an indication to the second agent that no relevant personalization setting is stored.

In some examples, the second agent may track multiple instances of the virtualized operating environment on the second device. For instance, the second device may produce multiple instances of a virtualized operating environment (e.g., remote desktop, application, etc.) corresponding to the same user profile and/or different user profiles. The instances may be tracked based on user profile and/or device identity. In some examples, the personalization settings request may indicate a corresponding user profile and/or device identity. The apparatus may receive, store, and/or send separate (e.g., different) personalization settings corresponding to different user profiles and/or devices.

In some examples, an operation or operations described in relation to FIG. 1 may be performed for multiple personalization settings. For instance, the apparatus may receive multiple personalization settings from a first agent. In some examples, the apparatus may send the multiple personalization settings to a second agent.

In some examples, the apparatus may provide a management environment. A management environment is a program or application executed on a computing device (e.g., apparatus and/or management server, etc.) to manage a device or devices. For instance, a management environment may operate on a computing device (e.g., networked device, cloud device, etc.) that is associated with (e.g., linked to) a device or devices. Some of the techniques described herein may be provided by the management environment on the apparatus. In some examples, the management environment may enable setting personalization settings based on an input from an end user, an information technology (IT) administrator, and/or an IT decision maker (ITDM), etc. In some examples, the management environment may be provided (e.g., hosted) by an apparatus (e.g., apparatus 302 described in relation to FIG. 3). In some examples, the management environment may manage personalization settings of a device or devices within a management domain.

In some examples, the management environment may provide a structure (e.g., graph structure, map, etc.) that represents devices in the management domain. In some examples, the management environment may provide a representation of the structure in a UI. For instance, the UI may depict devices in the management domain as images (e.g., icons). In some examples, the UI may depict (and/or may be utilized to access and/or modify) personalization settings corresponding to a user profile and/or device identity. In some examples, the UI may depict (and/or may be utilized to access and/or modify) operating environments with shared personalization settings. In some examples, operation(s), function(s), and/or element(s) of the method 100 may be omitted and/or combined.

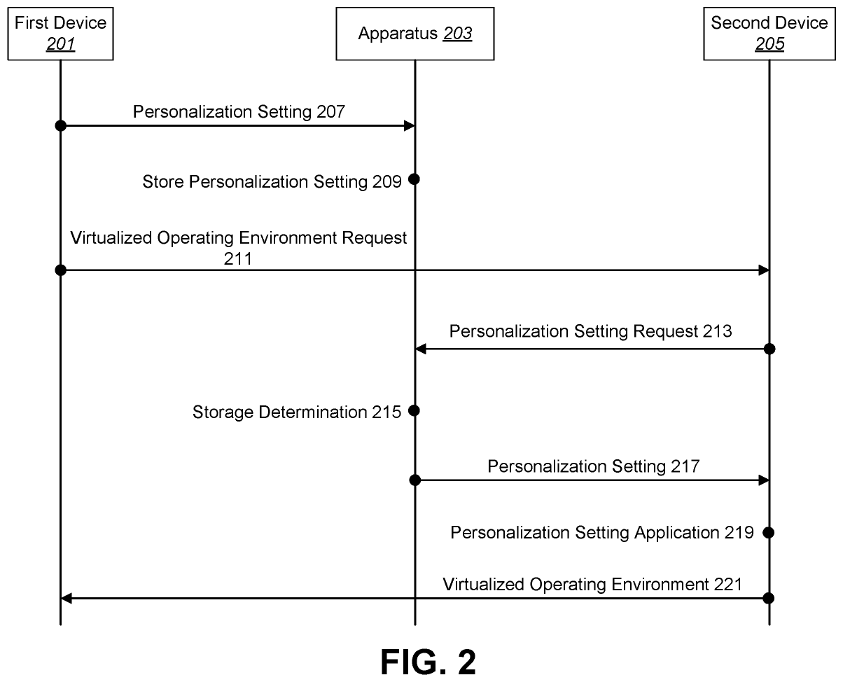

FIG. 2 is a thread diagram illustrating an example of operating environment personalization. FIG. 2 illustrates examples of a first device 201, an apparatus 203, and a second device 205. In some examples, the first device 201, the apparatus 203, and/or the second device 205 may be examples of the first device, apparatus, and/or second device described in relation to FIG. 1 and/or FIG. 3.

At 207, the first device 201 may send a personalization setting to the apparatus 203. For instance, a first agent on the first device 201 may detect a change in a personalization setting on the first device 201 and may trigger sending the personalization setting to the apparatus 203.

At 209, the apparatus 203 may store the personalization setting. For instance, the apparatus 203 may store the personalization setting and/or may update a record of personalization settings corresponding to a user profile and/or corresponding to the first device 201.

At 211, the first device 201 may send a virtualized operating environment request to the second device 205. For instance, the first device 201 may receive an input from a user indicating a command to access a virtualized operating environment. In response, the first device 201 may send the virtualized operating environment request to the second device 205.

At 213, the second device 205 (e.g., second agent) may send a personalization setting request to the apparatus 203. For example, in response to the virtualized operating environment request, the second device 205 may request that the apparatus 203 provide any personalization setting corresponding to the virtualized operating environment. In some examples, the personalization setting request 213 may indicate the virtualized operating environment, a user profile, and/or a device identity corresponding to the virtualized operating environment request.

At 215, the apparatus 203 may determine whether a personalization setting is stored corresponding to the virtualized operating environment provided by the second device 205. For instance, the apparatus 203 may determine whether a personalization setting is stored corresponding to the virtualized operating environment, the user profile, and/or the device identity. In response to determining that the personalization setting is stored, the apparatus 203 may send the personalization setting 217 to the second device 205 at 217.

At 219, the second device 205 (e.g., second agent) may apply the personalization setting to the virtualized operating environment. At 221, the second device 205 may provide (e.g., send, host, etc.) the virtualized operating environment 221 for the first device 201.

FIG. 3 is a block diagram of an example of an apparatus 302 that may be used for operating environment personalization. The apparatus 302 may be a computing device, such as a server computer, a personal computer, a laptop computer, etc. The apparatus 302 may include a processor 304, a memory 306, and/or a communication interface 324. The apparatus 302 may include additional components (not shown) and/or some of the components described herein may be removed and/or modified without departing from the scope of this disclosure.

The processor 304 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. The processor 304 may fetch, decode, and/or execute instructions stored in the memory 306. In some examples, the processor 304 may include an electronic circuit or circuits that include electronic components for performing a function or functions of the instructions. In some examples, the processor 304 may perform one, some, or all of the operations, aspects, etc., described in relation to one, some, or all of FIGS. 1-4. For example, the memory 306 may store instructions for one, some, or all of the operations, aspects, etc., described in relation to one, some, or all of FIGS. 1-4. The processor 304 may be coupled to (e.g., may be in electronic communication with) the memory 306.

The memory 306 may be any electronic, magnetic, optical, or other physical storage device that contains or stores electronic information (e.g., instructions and/or data). The memory 306 may be, for example, Random Access Memory (RAM), EEPROM, a storage device, an optical disc, and/or the like. In some examples, the memory 306 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some examples, the memory 306 may be a non-transitory tangible machine-readable storage medium, where the term “non-transitory” does not encompass transitory propagating signals. In some examples, the memory 306 may include multiple devices (e.g., a RAM card and a solid-state drive (SSD)). In some examples, the memory 306 of the apparatus 302 may store communication setup instructions 310.

In some examples, the apparatus 302 may include a communication interface 324 through which the processor 304 may communicate with an external device or devices (e.g., the first device 328 and/or the second device 308). In some examples, the apparatus 302 may be in communication with (e.g., have a communication link with) the first device 328 and/or the second device 308 via a network 326. Examples of the first device 328 may include a computing device. Examples of the second device 308 may include a computing device (e.g., virtual application server). Examples of the network 326 may include a local area network (LAN), wide area network (WAN), the Internet, cellular network, Long Term Evolution (LTE) network, 5G network, and/or combinations thereof, etc. In some examples, the apparatus 302 may be a cloud device. In some examples, the apparatus 302 may be a management server.

The communication interface 324 may include hardware and/or machine-readable instructions to enable the processor 304 to communicate with the first device 328 and/or the second device 308. The communication interface 324 may enable a wired and/or wireless connection to the first device 328 and/or to the second device 308. In some examples, the communication interface 324 may include a network interface card and/or may also include hardware and/or machine-readable instructions to enable the processor 304 to communicate with the first device 328 and the second device 308. In some examples, the communication interface 324 may include hardware (e.g., circuitry, ports, connectors, antennas, etc.) and/or machine-readable instructions to enable the processor 304 to communicate various input and/or output devices, such as a keyboard, a mouse, a display, another apparatus, electronic device, computing device, etc., through which a user may input instructions and/or data into the apparatus 302. In some examples, the apparatus 302 (e.g., processor 304) may utilize the communication interface 324 to send and/or receive information.

In some examples, the first device 328 may include a processor, memory, and/or communication interface. In some examples, the memory of the first device 328 may be any electronic, magnetic, optical, or other physical storage device that contains or stores electronic information (e.g., instructions and/or data), such as, for example, RAM, EEPROM, a storage device, an optical disc, and/or the like. In some examples, the processor of the first device 328 may be any of a CPU, a DSP, a semiconductor-based microprocessor, GPU, FPGA, an ASIC, and/or other hardware device suitable for retrieval and execution of instructions stored in corresponding memory. In some examples, the communication interface of the first device 328 may include hardware and/or machine-readable instructions to enable the first device 328 to communicate with the apparatus 302 and/or with the second device 308.

In some examples, the second device 308 may include a processor, memory, and/or communication interface. In some examples, the memory of the second device 308 may be any electronic, magnetic, optical, or other physical storage device that contains or stores electronic information (e.g., instructions and/or data), such as, for example, RAM, EEPROM, a storage device, an optical disc, and/or the like. In some examples, the processor of the second device 308 may be any of a CPU, a DSP, a semiconductor-based microprocessor, GPU, FPGA, an ASIC, and/or other hardware device suitable for retrieval and execution of instructions stored in corresponding memory. In some examples, the communication interface of the second device 308 may include hardware and/or machine-readable instructions to enable the second device 308 to communicate with the apparatus 302 and/or with the first device 328.

In some examples, the communication interface 324 may receive a first message from a first agent on the first device 328 that provides an operating environment (e.g., local operating environment). For instance, the communication interface 324 may receive a first message indicating a request to set up communication between the first device 328 and the second device 308 to access a virtualized operating environment (e.g., virtualized application) provided by the second device 308.

The processor 304 may execute the communication setup instructions 310 to set up, based on the first message, communication between the first agent on the first device 328 and a second agent on the second device 308 that provides a virtualized application (to a user, for instance). In some examples, the processor 304 may set up communication to coordinate a personalization setting between the operating environment (e.g., local operating environment provided by the first device 328) and the virtualized application.

In some examples, the processor 304 may set up the communication by controlling the communication interface 324 to send an address of the second device 308 and/or other information (e.g., authentication information) to the first device 328. The first device 328 may utilize the address of the second device 308 and/or the other information to establish communication with the second device 308. In some examples, the processor 304 may set up the communication by controlling the communication interface 324 to send an address of the first device 328 and/or other information (e.g., authentication information) to the second device 308. The second device 308 may utilize the address of the first device 328 and/or the other information to establish communication with the first device 328. In some examples, the communication is a peer-to-peer communication that excludes the apparatus 302. For instance, once the peer-to-peer communication is set up, the first agent on the first device 328 and the second agent on the second device 308 may communicate personalization setting(s). The first agent on the first device 328 and/or the second agent on the second device 308 may coordinate the personalization setting(s). For instance, the second device 308 may apply the personalization setting(s) to the virtualized application such that the personalization behavior of the virtualized application is similar to and/or matches the personalization behavior of the operating environment of the first device 328.

In some examples, the processor 304 may set up the communication by controlling the communication interface 324 to request a link with the second device 308. In response, the second device 308 may establish a link with the apparatus 302. In some examples, the communication is relayed by the apparatus 302. For instance, once the relayed communication is set up, the first agent on the first device 328 and/or the second agent on the second device 308 may communicate personalization setting(s) relayed through the apparatus 302. In some examples, relaying a personalization setting may be performed as described in relation to FIG. 1 and/or FIG. 2. For example, the apparatus 302 may relay a personalization setting from the first device 328 to the second device 308. The second device 308 may apply the personalization setting to the virtualized application such that the personalization behavior of the virtualized application is similar to and/or matches the personalization behavior of the operating environment of the first device 328.

In some examples, the apparatus 302 may provide a management environment. The management environment may be utilized to perform some examples of the techniques described herein. For example, the management environment may provide capabilities to control, manage, and/or delegate settings from the apparatus 302 (e.g., IT administrator) to a device or devices over the network 326. In some examples, the management environment may provide integration of personalization settings from an operating environment into a management domain to provide a similar and/or matching graphical user interface (GUI) across OS versions and archetypes. A management domain is a group of devices managed in a management environment. In some examples, the management environment may utilize on-device agents to facilitate remote management and/or local management of personalization settings. In some examples, the management environment may support the ability to assign and delegate personalization settings for specific user profiles (such as for domain users) within an entity (e.g., business, enterprise, organization, etc.). This support may enable the management environment to manage personalization settings on behalf of a user or users of a device or devices (e.g., the first device 328).

In some examples, the management environment may expose a management agent architecture to virtualized operating environments (e.g., workspaces), which may allow an agent to monitor, modify, and/or control personalization settings on behalf of individual users within a virtualized operating environment. In some examples, the management environment may utilize IT administrator input to control personalization settings directly and/or may delegate control to an agent based on user input.

In some examples, inter-process communication controls may be integrated between an agent on a local computing device (e.g., a first agent on the first device 328) and an agent or agents hosted within virtual infrastructure (e.g., a second agent on the second device 308). In some examples, centralized communication may be carried out by the apparatus 302. For instance, centralized communication may be accomplished using a server message broker in the management environment. In some examples, negotiated peer-to-peer based communication may be performed using the apparatus 302 (e.g., management environment) as a switchboard. In some examples, communication may be carried out using a custom data format registration of clipboard objects and clipboard monitoring in endpoint operating systems. In some examples, other distributed communication protocols and/or service discovery approaches may be utilized.

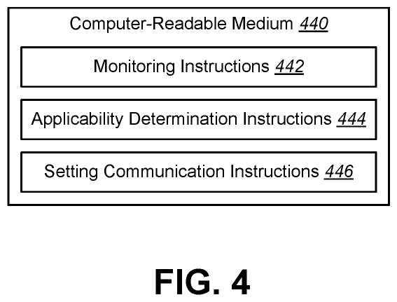

FIG. 4 is a block diagram illustrating an example of a computer-readable medium 440 for operating device personalization. The computer-readable medium is a non-transitory, tangible computer-readable medium 440. The computer-readable medium 440 may be, for example, RAM, EEPROM, a storage device, an optical disc, and/or the like. In some examples, the computer-readable medium 440 may be volatile and/or non-volatile memory, such as DRAM, EEPROM, MRAM, PCRAM, memristor, flash memory, and/or the like. In some examples, the memory 306 described in relation to FIG. 3 may be an example of the computer-readable medium 440 described in relation to FIG. 4.

The computer-readable medium 440 may include data (e.g., instructions, executable code, application(s), program(s), and/or information). For example, the computer-readable medium 440 may include monitoring instructions 442, applicability determination instructions 444, and/or setting communication instructions 446.

The monitoring instructions 442 may be executed by a processor to monitor a personalization setting from a first agent on a first device that provides a local operating environment. In some examples, monitoring the personalization setting may be accomplished as described in relation to FIG. 1, FIG. 2, and/or FIG. 3. For instance, an apparatus may receive a personalization setting from a first agent on a first device. In some examples, the first agent may send the personalization setting in response to detecting a setting change. In some examples, the computer-readable medium 440 may include instructions when executed cause the processor to utilize a clipboard application programming interface (API) to monitor the personalization setting. In some examples, the computer-readable medium 440 may include instructions when executed cause the processor to utilize a sideband of a remote desktop protocol (RDP) to monitor the personalization setting. For instance, the first agent may send the personalization setting on a sideband of the RDP. The processor may recognize and/or receive the personalization setting on the sideband of the RDP.

The applicability determination instructions 444 may be executed by a processor to perform a determination as to whether the personalization setting from the first agent is applicable to a virtualized operating environment provided by a second device. This may be accomplished as described in relation to FIG. 1 and/or FIG. 2 in some examples. For example, the processor may determine whether the virtualized operating environment (e.g., a virtualized application instance, remote desktop, etc.) is associated with a user profile that also corresponds to the personalization setting. In some examples, the processor may determine whether the personalization setting corresponds to a type of the virtualized operating environment provided (for a user profile, for instance) by the second device. For instance, the processor may determine whether a personalization setting indicating a playback speed setting is applicable to a type of virtualized application (e.g., streaming application or word processing application) provided by the second device. For example, the playback speed setting may be applicable to a streaming application but may not be applicable to a word processing application. In some examples, the processor may determine applicability by determining whether the virtualized operating environment includes a setting that corresponds to the personalization setting.

The setting communication instructions 446 may be executed by the processor to send the personalization setting to a second agent on the second device in response to the determination that the personalization setting is applicable to the virtualized operating environment. This may be accomplished as described in relation to FIG. 1 and/or FIG. 2 in some examples.

Some examples of the techniques described herein may provide a holistic view of personalization settings at the management domain level. Some examples may enable propagating personalization settings over multiple operating environments. For instance, setting a personalization setting in one operating environment may trigger updating corresponding personalization settings in other operating environments. Some examples of the techniques described herein may provide visibility into rapid personalization setting changes across multiple operating environments.

Some examples of the techniques described herein may provide compatible (e.g., OS-agnostic) settings that span operating system versions and operating system archetypes. Some examples of the techniques described herein provide a follower approach to personalization settings that maps settings to any operating environment that a user may access.

In some examples, a personalization setting conflict may occur. For instance, the localized operating environment may have a first personalization setting that is different from a second personalization setting of the virtualized operating environment. In some approaches, an apparatus and/or agent(s) may maintain the different settings (e.g., light mode in the local operating environment and dark mode in the virtualized operating environment). In some examples, an apparatus and/or agent(s) may apply a personalization setting with a priority. For instance, a personalization setting from a local operating environment may be given a priority or a most recently changed personalization setting may be given a priority. In some examples, the apparatus may receive an input indicating a priority or priority rule (e.g., whether settings from a local or virtualized operating environment have priority, whether a most recent setting change has a priority, etc.).

Some of the examples described herein may help to provide a more uniform user experience across operating environments based on personalization settings that may be shared across the operating environments. Some examples may increase the quality of the user experience when working with multiple operating environments.

Some of the examples described herein may be utilized in scenarios where, in a virtualized application environment, a virtualization stack is running and/or allocated. Some of the examples described herein may be utilized in scenarios where a virtualization session may be initiated based on personalization settings and/or a user profile to guide the setup of the virtualization session.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples of systems and methods are described herein, the systems and methods are not limited to the examples. Variations of the examples described herein may be implemented within the scope of the disclosure. For example, operations, aspects, and/or elements of the examples described herein may be omitted or combined.

What is claimed is:

1. A method, comprising:
receiving a personalization setting from a first agent on a first device, wherein the first device provides a local operating environment; and
sending the personalization setting to a second agent on a second device that provides a virtualized operating environment, to coordinate a behavior or appearance of the virtualized operating environment with a personalized behavior or appearance of the local operating environment.

2. The method of claim 1, wherein the local operating environment is produced with a first operating system and the virtualized operating environment is produced by a different second operating system.

3. The method of claim 1, wherein the personalization setting is translated from a local personalization setting that is specific to the local operating environment to a second personalization setting that is compatible with the virtualized operating environment.

4. The method of claim 1, further comprising storing the personalization setting in association with a user profile.

5. The method of claim 4, further comprising:
receiving a personalization setting request from the second agent triggered based on a request for the virtualized operating environment from the first device; and
determining that the personalization setting is stored.

6. The method of claim 5, wherein sending the personalization setting to the second agent is in response to determining that the personalization setting is stored.

7. The method of claim 1, wherein the personalization setting is an application layer setting.

8. The method of claim 1, wherein the personalization setting is a hardware device setting.

9. The method of claim 1, wherein the second agent is to track multiple instances of the virtualized operating environment on the second device.

10. An apparatus, comprising:
a communication interface to receive a first message from a first agent on a first device that provides an operating environment;
a memory; and
a processor coupled to the memory, wherein the processor is to:
set up, based on the first message, communication between the first agent on the first device and a second agent on a second device that provides a virtualized application to coordinate a personalization setting between the operating environment and the virtualized application.

11. The apparatus of claim 10, wherein the communication is a peer-to-peer communication that excludes the apparatus.

12. The apparatus of claim 10, wherein the communication is relayed by the apparatus.

13. A non-transitory tangible computer-readable medium comprising instructions when executed cause a processor to:
monitor a personalization setting from a first agent on a first device that provides a local operating environment;
perform a determination as to whether the personalization setting from the first agent is applicable to a virtualized operating environment provided by a second device; and
send the personalization setting to a second agent on the second device in response to the determination that the personalization setting is applicable to the virtualized operating environment.

14. The non-transitory tangible computer-readable medium of claim 13, further comprising instructions when executed cause the processor to utilize a clipboard application programming interface (API) to monitor the personalization setting.

15. The non-transitory tangible computer-readable medium of claim 13, further comprising instructions when executed cause the processor to utilize a sideband of a remote desktop protocol (RDP) to monitor the personalization setting.
